(19) United States
(12) Patent Application Publication
(10) Pub. No.: US 2017/0218860 A1
(43) Pub. Date: Aug. 3, 2017

(54) ENGINE SYSTEM WITH INFERENTIAL SENSOR

(71) Applicant: Honeywell International Inc., Morris Plains, NJ (US)

(72) Inventors: Daniel Pachner, Praha (CZ); Dejan Kihas, Burnaby (CA); Lubomir Baramov, Praha (CZ)

(21) Appl. No.: 15/011,445

(22) Filed: Jan. 29, 2016

(51) Int. Cl. F02D 41/00; F02D 35/02

(52) U.S. Cl. CPC F02D 41/0007; F02D 35/023; F02D 35/025; F02D 2200/0406

(57) ABSTRACT

An engine system incorporating an engine, one or more sensors, and a controller. The controller may be connected to the one or more sensors and the engine. The one or more sensors may be configured to sense one or more parameters related to operation of the engine. The controller may incorporate an air-path state estimator configured to estimate one or more air-path state parameters in the engine based on values of one or more parameters sensed by the sensors. The controller may have an on-line and an off-line portion, where the on-line portion may incorporate the air-path state estimator and the off-line portion may configure and/or calibrate a model for the air-path state estimator.

### BACKGROUND

The present disclosure pertains to internal combustion engines and particularly to engines having one or more sensors.

### SUMMARY

The disclosure reveals an engine, one or more sensors, and a controller integrated into an engine system. The controller may be one or more control units connected to the engine and/or the one or more sensors. The controller may contain and execute a program for control of the engine system or for diagnostics of the engine system. The controller may incorporate an air-path state estimator configured to estimate one or more air-path state parameters related to the operation of the engine based, at least in part, on values of one or more parameters sensed by the sensors. In an off-line portion of the controller calibration algorithm, a model for the air-path state estimator may be configured and/or calibrated for the engine. The configured and/or calibrated model may be provided to the air-path state estimator in an on-line portion of the controller to provide air-path state parameter value estimates in real-time during operation of the engine.

### BRIEF DESCRIPTION OF THE DRAWING

FIG. 1 is a diagram of an illustrative example of an engine system;

FIG. 2 is a diagram of an illustrative example of a controller or diagnostic system having an on-line portion and an off-line portion;

FIG. 3 is a diagram of an illustrative example approach of configuring and using a calibrated model on a controller or diagnostic system having an on-line portion and an off-line portion; and

FIG. 4 is a diagram of an illustrative example approach of using a controller with a calibrated algorithm.

### DESCRIPTION

The present system and approach may incorporate one or more processors, computers, controllers, user interfaces, wireless and/or wire connections, and/or the like, in an implementation described and/or shown herein.

This description may provide one or more illustrative and specific examples or ways of implementing the present system and approach. There may be numerous other examples or ways of implementing the system and approach.

Modern combustion engines may be complex systems with modern engine control or diagnostics systems that are model based and implemented with model based software in a controller (e.g., one or more electronic control unit (ECU) or electronic control module (ECM) having one or more control algorithms) of an engine system. However, an engine model may not need to be complex and/or difficult to run in a simulation to be an accurate model of an engine. In one example, there may exist different models with similar input and output behavior, but with dramatically different numerical properties, solution complexity, and requirements for computational power. Thus, as a control system memory footprint and/or computational power needed by model based software in which the engine model (e.g., an engine model used in a control system) is implemented, may be largely dependent on the model complexity and numerical properties for the model; it may be effective to have a simple and numerically convenient engine model that may meet a required accuracy level when implementing a real-time model based estimator, inferential sensor, and/or controller (e.g., for controlling an engine).

Differential equations resulting from combustion engine physics may be stiff and difficult to solve numerically, particularly in real time during operation of an engine. In one example, a gas exchange model of an internal combustion engine air path (e.g., a model of engine breathing) resulting from first principles of physics may be a set of ordinary differential equations (ODEs) that is highly complex:

$$\frac{dx \text{?}}{dt} = {f}_{j} ( t , {x}_{1} , {x}_{2} , … , \text{?} ) \text{?} j ∈ \{ 1 , 2 , … , \text{?} \} \text{?} \\ \text{?} \text{indicates text missing or illegible when filed} \qquad ( 1 )$$

Here xⱼ may be state variables of the internal combustion engine air path and t may be time. The ODE model of equation (1) may be considered to be very stiff and numerically inconvenient. Illustratively, the model stiffness may be caused by the form of equation (1), which may have non-linear components and/or components that are described by non-differentiable functions. The numerical properties of the model represented by equation (1) (e.g., a mean value model of an internal combustion engine, which is a model that may be averaged over an engine cycle) may be fully defined by right-hand side functions, fⱼ. These functions, fⱼ, may have numerical properties that could result in the equations being difficult to solve. For example, the functions on the right-hand side of the equation may include non-linear components and/or may not be differentiable because, in this example, the functions' derivatives with respect to x are not bounded for some values of x. Examples of functions with non-linear components and/or that are not differentiable may include functions with derivatives that include power functions with an exponent less than one, or ratios of functions, and/or other complex functions composed from rational and power functions, where the denominator may be zero or tend to (e.g., approach or become close to) zero. These functional forms may be completely correct for modeling an engine as they may be given by physics of gas and energy flow in the engine, but the complexity of the numerical properties of functions including these functional forms may make it difficult to use the functions in fast simulations and/or real-time optimizations (e.g., to model engines during operation of the engine).

When calculating local linearization of differential equations, such as in equation (1) close to a point where some of fⱼ are not differentiable, a Jacobian matrix j, as seen in equation (2) may be ill-conditioned.

$$\text{?} = ( \begin{matrix}\frac{\partial {f}_{1}}{\partial {x}_{1}} & … & \frac{\partial {f}_{n}}{\partial {x}_{1}} \\ ⋮ & ⋱ & ⋮ \\ \frac{\partial {f}_{1}}{\partial {x}_{1}} & … & \frac{\partial {f}_{n}}{\partial {x}_{n}}\end{matrix} ) \\ \text{?} \text{indicates text missing or illegible when filed} \qquad ( 2 )$$

In some cases, the ill-conditioning may be caused by some of the partial derivatives being unbounded. As a result, eigenvalues of the Jacobian matrix may have differing magnitudes and may produce model stiffness. Moreover, model stiffness may tend to worsen when approaching points of unbounded Jacobian elements and in a limit; the ratio of eigenvalues may tend to infinity. Stiff model simulation (e.g., simulation of a model represented by equation (1)) may be possible with specially configured solvers, but the processing power needed may be too great to solve on a controller configured to control an engine (e.g., one or more ECUs and/or ECMs).

Instead of simulating a stiff model, an original physical model (e.g., a model of the engine that may be stiff) that may be changed to a set of equations, which may be much easier to solve (e.g., easier to solve from a computational or processing power perspective), may be utilized to model the engine. An example approach of transforming the stiff engine model to a more easily solved engine model that may be the same or lower order than the stiff engine model may include transforming the right-side functions of the engine models derived from first principles of physics (e.g., equation (1)) with fractions of differentiable functions. Then the differential equations with denominators that tend to zero may be converted to implicit equations after which the stiffness (e.g., fast dynamics) from the engine model may be mitigated and/or eliminated. This may result in a differential algebraic equation (DAE) model structure. After mitigating and/or eliminating the stiffness from the engine model, a transformed solution of eliminated states may be provided and the transformed solutions may replace the eliminated states in the DAEs and differentiable functions. Such an approach may be described as follows.

ODE models of a system may be changed into or converted to a differential algebraic equation (DAE) model of the system. A classic model of a dynamic system may be a set of first order differential equations in the time domain, as follows:

$$\frac{dx ( t )}{dt} = f ( t , x ( t ) ) \qquad ( 3 )$$

In some cases, as discussed herein, control oriented models used in an automotive industry (e.g., for internal combustion engines) may have the form of equation (3). Such ODE functions may not necessarily be convenient, but an ODE function may be converted to a DAE that may be more convenient and may be an implicit equation taking a general form of:

$$F ( \frac{dx ( t )}{dt} , t , x ( t ) ) = 0 \qquad ( 4 )$$

Further, it may be possible to isolate the time derivatives from equation (4), which may result in a model having a semi-explicit form with the following equations:

$$\begin{matrix}\frac{{dx}_{1} ( t )}{dt} = {f}_{1} ( t , {x}_{1} ( t ) , {x}_{2} ( t ) ) & ( 5 ) \\ 0 = {f}_{2} ( t , {x}_{1} ( t ) , {x}_{2} ( t ) ) & ( 6 )\end{matrix}$$

It has been found that an ODE model of an internal combustion engine (e.g., similar to equation (1)) may be converted to a DAE model automatically or semi-automatically with minimum effort using the disclosed approach. The initial transformation step of the approach may replace some of the right hand side functions (e.g., functions, fᵢ) with multivariate rational polynomials functions and remaining functions (e.g., functions, fₖ) with multivariate polynomial functions. An example rational polynomial function follows:

$$\frac{{dx}_{\text{?}}}{dt} = \frac{{b}_{\text{?}} ( t , {x}_{1} , {x}_{2} , … , {x}_{n} )}{{a}_{\text{?}} ( t , {x}_{1} , {x}_{2} , … , {x}_{n} )} , t ∈ E . \\ \text{?} \text{indicates text missing or illegible when filed} \qquad ( 7 )$$

Rational polynomials functions may be used to transform the non-differentiable functions (e.g., the square root functions if the argument is not sufficiently non-zero, similar functions appearing in the laws of thermodynamics, chemical kinetics, turbo-machinery, and so forth). Such functions may be the type used to model compressible fluid orifice flow, and the like in an internal combustion engine, and/or used to model other systems. The choice of transforming functions with rational polynomial functions may be of interest, as polynomial functions, for example, may be less efficient for transforming non-differentiable functions than rational polynomials.

The remaining functions, fₖ, may either be smooth and differentiable or may be considered practically differentiable, where non-differentiability of the function may not happen for normal values of x. These functions fₖ may be transformed with the following polynomial functions:

$$\frac{{dx}_{\text{?}}}{dt} = {p}_{k} ( t , {x}_{1} , {x}_{2} , … , {x}_{n} ) , k \text{?} E . \\ \text{?} \text{indicates text missing or illegible when filed} \qquad ( 8 )$$

The second step of the approach may incorporate multiplication of the transformed equations tεE (e.g., the rational polynomials, as in equation (7)) with the denominators, resulting in the following equation:

$$\frac{{dx}_{\text{?}}}{dt} = {a}_{\text{?}} ( t , {x}_{1} , {x}_{2} , … , {x}_{n} ) - {b}_{\text{?}} ( t , {x}_{1} , {x}_{2} , … , {x}_{n} ) = 0. \\ \text{?} \text{indicates text missing or illegible when filed} \qquad ( 9 )$$

This step of the approach may result in a system with implicit but differentiable equations. That is, the non-differentiability in the functions may be removed by the multiplication.

The third step may include removing model stiffness (e.g., eliminating the fast dynamics) from the model. In one example, this step may replace, if there are any, denominators aᵢ(t,x₁,x₂, . . . ,xₙ) which can get small (e.g., tend to zero). From this, some equations may be changed into the following algebraic equations:

bᵢ(t,x₁,x₂, . . . ,xₙ)=0 (10)

After this step, the system of ODEs (e.g., as in equation (1)) may be changed into a system of DAEs with differentiable functions, which may be equivalent to assuming all or substantially all fast dynamics of the functions may be in steady state.

At the next step, the variables xᵢ may be isolated from the algebraic polynomial equations bᵢ=0. Typically it may not be possible to do this step analytically, as the variables xₛ may only be approximately isolated. This transformation may be represented by multivariate polynomial functions gᵢ, as follows:

xᵢ=(gᵢ(t,xₖ),kεE. (11)

Next, using the results from the previous step, the eliminated states xᵢ may be replaced with gᵢ(t,xₖ) in the remaining differential equations. Thus the DAEs may become a smaller system (e.g., lower order than equation (1)) of ODE's, which may transform the original model (e.g., equation (1)):

$$\frac{{dx}_{\text{?}}}{dt} = {p}_{k} ( t , \text{?} ( t , {x}_{k} ) , {x}_{k} ) = {q}_{k} ( t , {x}_{k} ) . \\ \text{?} \text{indicates text missing or illegible when filed} \qquad ( 12 )$$

Here, the polynomial functions qₖ(t,xₖ) may be differentiated analytically, so the Jacobian matrix may be prepared for real-time control optimization and state estimation tasks (e.g., when implementing in an ECM to control an engine and/or in one or more other control applications or other applications).

Turning to one example implementation of the above conversions with respect to modeling an internal combustion engine, such a conversion technique may be used to configure a virtual sensor (e.g., inferential or soft sensor) that uses measurements or values from physical sensors sensing parameters of an engine to estimate and/or determine values for parameters related to the engine that may or may not be sensed by physical sensors. Such virtual sensors may include an air-path state estimator, a NOx concentration sensor, a turbocharger speed sensor, one or more other virtual sensors, and any combination of virtual sensors. Although the disclosed subject matter may be described with respect to an example related to air-path state estimation and NOx concentration virtual sensing that may output NOx concentration values in exhaust gas from an engine, the concepts herein may be utilized in other virtual sensors of an engine or other system and/or in other models where processing power may be limited. The virtual sensor, along with any control program of the controller, may be implemented in memory as software code compiled and executed by a processor of the controller.

Illustratively, NOₓ (e.g., where NOₓ may be a general term used to describe mono-nitrogen oxides NO and NO₂) emissions from an internal combustion engine may be strictly regulated by authorities (e.g., government authorities). NOx may be produced in a cylinder of an engine as a result of oxidation of atmospheric Nitrogen. An oxidation rate of atmospheric Nitrogen in exhaust gas from an engine may be dependent on a temperature and an amount of oxygen available. An ECU/ECM or other controller may adjust control parameters for the engine in real time in order to avoid conditions which may lead to excessive NOx formation in a combustion chamber of the engine. As a result, a controller (e.g., one or more ECU/ECM and/or other controller) may be configured to monitor temperature and oxygen content in the combustion chamber of the engine. In one example, the controller may be configured to avoid high temperatures in a cylinder of an engine in combination with lean combustion (e.g., combustion with excess oxygen). Such monitoring may be particularly relevant when an engine is not equipped with de-NOx technology (e.g., most small and medium diesel vehicles do not include such de-NOx technology). In some cases, a controller may utilize a feedback loop because the NOx formation process may be affected by one or more uncertain variables affecting the combustion process (e.g., fuel composition, how fuel may be atomized during injection, combustion delay, exact mass and composition of gas charged to the cylinder of the engine, and so on).

Reliable feedback control of the NOx emissions may be based on a physical NOx on-board sensor/analyzer. In one example, a physical sensor/analyzer may convert NOx concentration to an electrical voltage. However, such a physical sensor/analyzer may be a relatively costly device, and ensuring its reliable operation over the entire vehicle life may be difficult, as the physical sensor/analyzer may operate in the exhaust stream where the conditions may be harsh. Another problem with a physical sensor/analyzer may be cross-sensitivity of the sensor/analyzer to compounds different than NOx (e.g., ammonia, and so on).

For these reasons, a virtual sensor (e.g., a soft or inferential sensor) may be used to estimate NOx production from an engine based, at least in part, on other variables which can be measured on the engine as an alternative to, or in addition to, a NOx physical sensor/analyzer. Even if this soft sensing may not completely replace the NOx physical sensor/analyzer, it may help with sensor diagnostics and/or sensor health monitoring, as well as cross sensitivity issues.

Based, at least in part, on sensed parameters of physical sensors already in the engine, a NOx production rate or other engine parameter may be estimated by solving chemical kinetics equations in the in-cylinder space (e.g., in an in-cylinder space of an engine), while respecting the volume profile which may be given by the engine speed. Physical sensors in the engine may be able to facilitate determining initial conditions to solve these chemical kinetics equations and/or other equations related to determining parameter values. Notably variables including, but not limited to, mass, temperature, and chemical composition of the charged gas of the engine (which may not necessarily be fresh air, but may be a mixture of air and combustion product residuals) may be required to be known as initial conditions for solving the chemical kinetics equations and/or the other equations for estimating a parameter value. Additionally, and/or alternatively, other variables such as, but not limited to, an amount of injected fuel, injection timing, and gas composition may be required.

Initial conditions for estimating NOx production and/or for estimating other parameters of an engine or engine system may be estimated rather than sensed by physical sensors of the engine. As such, a virtual sensor or estimator module based on a gas exchange model may output temperature, composition, and mass of the charged gas, which may be utilized as initial conditions in a second virtual sensor (e.g., a virtual sensor configured to produce NOx flow estimates based on the initial conditions estimates, a virtual sensor configured to estimate a speed of a turbo charger, and so forth).

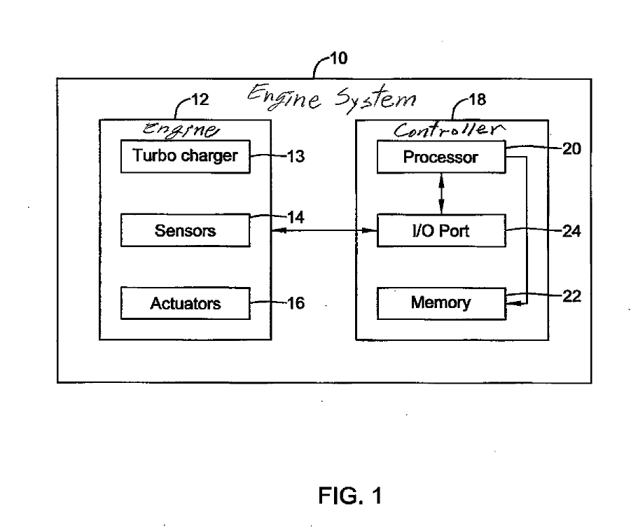

Turning to the Figures, FIG. 1 depicts an engine system 10. The engine system 10 may include an engine 12 and a controller 18 in communication with the engine 12. In some cases, the engine system 10 may include one or more additional components, including, but not limited to, a powertrain that may incorporate the engine 12, a powertrain controller, an exhaust gas aftertreatment system/mechanism, a drivetrain, a vehicle, and/or other component. Any reference herein to engine, powertrain, or aftertreatment system may be regarded as a reference to any other or all of these components.

The engine 12 may include one or more turbo chargers 13, one or more sensors 14, and one or more actuators 16. Examples of engine actuators 16 may include, but are not limited to actuators of a turbocharger waste gate (WG), a variable geometry turbocharger (VGT), an exhaust gas recirculation (EGR) system, a start of injection (SOI) system, a throttle valve (TV), and so on. The sensors 14 may be configured to sense positions of actuators and/or values of other engine variables or parameters and then communicate those values to the controller 18.

The controller 18 may be an ECM or ECU with a control system algorithm therein. The controller 18 may include one or more components having a processor 20, memory 22, an input/output (I/O) port 24, and/or one or more other components. The memory 22 may include one or more control system algorithms and/or other algorithms and the processor 20 may execute instructions (e.g., software code or other instructions) related to the algorithm(s) in the memory 22. The I/O port 24 may send and/or receive information and/or control signals to and/or from the engine 12. In one example, the I/O port 24 may receive values from the sensors 14 and/or send control signals from the processor 20 to the engine 12.

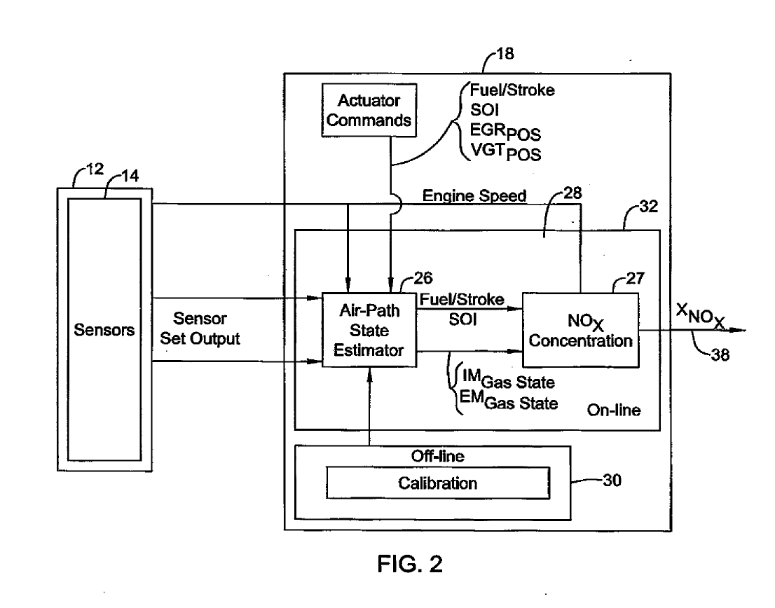

One illustrative example implementation of a virtual sensor in the engine system 10, the controller 18 of the engine system 10 may be configured to include a virtual sensor having two main components: 1) an air-path state estimator 26 (e.g., a virtual sensor or module that may provide an estimate of the air-path state in an engine based on actual measurements from sensors 14 in the engine 12), and 2) a NOx concentration module 27 (e.g., a NOx concentration virtual sensor having an in-cylinder process model of NOx formation). One may see FIG. 2. The air-path state estimator 26 may include a model of an air path of the engine averaged over an engine cycle. Such a model may be a model of a non-linear system with states that may be estimated on-line (e.g., during operation of the engine 12) using sensor measurements. The air-path state estimator 26 may provide boundary or initial values to one or more downstream sensors (NOx concentration module 27) and/or monitoring systems. In some cases, the air-path state estimator 26 may estimate one or more of an in-cylinder (e.g., a cylinder of the engine 12) charge temperature, an in-cylinder charge pressure, a concentration of gas at an intake valve closing, and/or one or more other parameters related to an air-path of an engine.

Virtual sensors utilizing initial conditions from the air-path state estimator 26 may be configured to run in real time on a vehicle controller or ECU (e.g., controller 18). The virtual sensor may able to predict or estimate engine parameter values (e.g., out-engine NOx concentration) with sufficient accuracy for both steady state and transient operation, while covering an entire or substantially an entire envelope of the engine and a relatively wide range of ambient conditions.

In some cases, model(s) of and/or used in the virtual sensors in controller 18 may include a number of parameters that may be calibrated in a series of experiments to achieve or improve accuracy of estimates from the virtual sensor. By considering physical interactions in the engine 12, the model of the virtual sensor may gain extrapolation ability to behave reasonably beyond a range of data used for calibration. Considering that the virtual sensor configuration may start from a physics based model, the calibrated parameters of the model may be mostly physical parameters with known physical interpretations and values known accurately or approximately. These physical parameters may be automatically transformed into other parameters (e.g., polynomial coefficients). This may distinguish the disclosed approach from other black-box modeling approaches (e.g., modeling not based on physics), where the parameters without a clear physical interpretation may be used for calibration and the calibration effort may be great because the number of completely unknown parameters is to be determined.

The model of the virtual sensor may be driven by variables of engine inputs and/or actuator positions. In one example, input variables may include EGR valve opening (U_{EGR}), VNT vane position, injected fuel quantity (fuel per stroke), ambient temperature, ambient pressure, ambient humidity, intake manifold pressure, intake manifold temperature, air mass flow (MAF), positions of a variable geometry turbocharger (U_{VGT}), and so on. Further, the model(s) in the virtual sensor may be affected by unmeasured disturbances such as variations in fuel quality, ambient air pressure, as well as variations in the operation of the engine 12 due to aging of components, but these effects may be compensated-for by using available sensor measurements by means of feedback corrections as it may be for state estimators (e.g., Kalman filter based state estimators).

FIG. 2 is a diagram that depicts a schematic view of a virtual sensor 28 of a controller 18. Controller 18 may have an off-line portion 30 and an on-line portion 32. The off-line portion 30 of the controller 18 may be configured to determine one or more differential functions of an engine model for use by the air-path state estimator 26 in estimating parameter values of the engine 12 during operation of the engine 12.

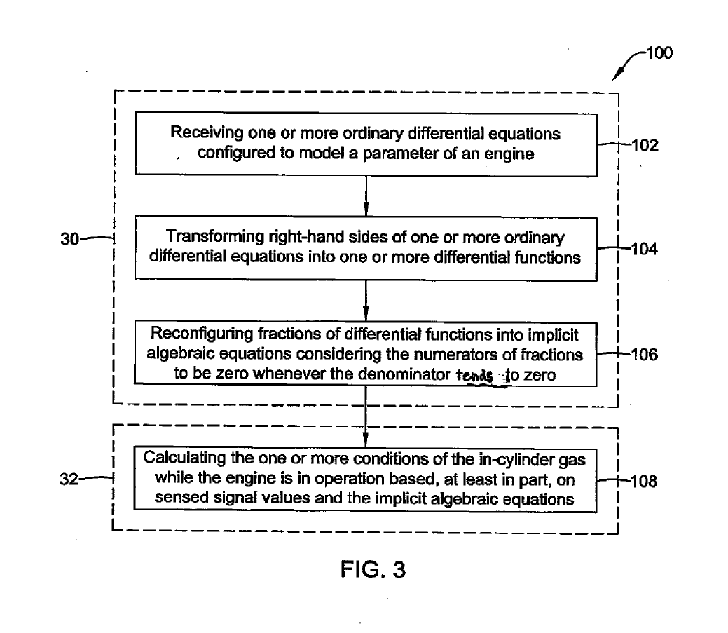

The off-line portion 30 of the controller 18 may be configured to calibrate a model of the engine 12 for the specific engine 12 without current operating conditions of the engine (e.g., conditions of the engine during operation of the engine). As such, the operation of the off-line portion 30 of the controller 18 may not receive feedback from the operation of the engine 12 and may be separate from a feedback loop of the engine 12 used to control operation of the engine 12. The operations of the off-line portion 30 of the controller 18 may be described in greater detail with respect to FIG. 3.

The off-line portion 30 of the controller 18 may be on the same or different hardware as the on-line portion 32 of the controller 18. In one example, the off-line portion 30 of the controller 18 may be performed or located on a personal computer, laptop computer, server, and the like, that may be separate from the ECU/ECM or other controller of engine 12. In the example, parameters for the engine model may be obtained off-line and uploaded to the ECU/ECM during a manufacturing process of the engine 12 and/or as a future update during vehicle service. Alternatively, or in addition, the off-line portion 30 of the controller 18 may be performed on the ECU/ECM at or adjacent the engine 12.

The on-line portion 32 of the controller 18 may be located in a feedback loop for controlling operation of the engine 12. As such, the on-line portion 32 may utilize current conditions of parameters of the engine 12 to adjust and/or monitor engine 12 operations and/or outputs.

In FIG. 2, a virtual sensor 28 at least partially located in the on-line portion 32 of the controller 18 may be split into two parts: 1) the air-path state estimator 26, and 2) the NOx concentration module 27 representing an engine cylinder combustion model. As discussed, the air-path state estimator 26 may be or may include a mean-value model, where the variables for the model may be averaged over an engine cycle. The air-path state estimator 26 role may be to track states of parameters in intake and/or exhaust manifolds, where the tracked states of parameters (e.g., traces of states) may be used as boundary conditions for the NOx concentration module 27 an/or other downstream virtual sensors or diagnostics. Examples of tracked states of parameters may include, but are not limited to, intake/exhaust manifold pressures, intake manifold temperature, fractions of the main species entering cylinders of the engine, which may include O₂, N₂, H₂O, and/or CO₂, and/or other states of engine related parameters.

In one example, the air-path state estimator 26 may be configured to estimate unmeasured inputs to the NOx concentration module 27, which may include manifold gas conditions (e.g., an intake and/or exhaust manifold temperatures, an intake and/or exhaust manifold pressures, and intake and/or exhaust manifold concentrations of O₂, N₂, H₂O, and/or CO₂), among other possible conditions. The intake manifold gas conditions may be utilized for the NOx concentration module 27, as the intake manifold gas conditions may define the gas charged to the cylinder and that definition may be needed to determine NOx formation. Additionally, in some cases, exhaust manifold gas conditions may be utilized for the NOx concentration module 27, as the exhaust manifold gas conditions may define properties of residual gas left in dead space of the engine 12.

Illustratively, the air-path state estimator 26 may be a non-linear state observer based on a set of differential equations normally defined by the mean value model of the engine. There may be four types of the differential equations and their exact number and configuration may be determined by the architecture of the engine 12. In one example, some factors that may affect the configuration of the differential equations include, but are not limited to, whether the engine includes a single or dual stage turbocharger, whether the engine has a low or high pressure EGR, whether the engine has a backpressure valve or an intake throttle valve, or the like.

One of the four types of differential equations may be the differential equation of pressure between components in a volume, V, of the engine 12:

$$\begin{matrix}dp \\ \text{?}\end{matrix} = \begin{matrix}\text{?} \\ {p}^{V}\end{matrix} ( \begin{matrix}{\text{?}}_{in} {T}_{in} & {\dot{m}}_{out} T\end{matrix} ) \\ \text{?} \text{indicates text missing or illegible when filed} \qquad ( 13 )$$

Here, \tilde{R} [J/(kg K)] is the gas constant, γ is dimensionless heat capacity ratio of the gas, T [K] is the temperature of gas in the volume V [m³], and p [Pa] is absolute pressure in the volume, and \dot{m}ᵢₙ and \dot{m}ₒᵤₜ [kg/s] are the mass of the gas into and out of the volume V, respectively. Another of the four types of differential equations may be the differential equation of temperature between components of the engine 12:

$$\frac{dT}{dt} = \frac{\tilde{R} T}{{c}_{V} pV} ( {c}_{p} {T}_{in} {\dot{m}}_{in} - {c}_{p} T {\dot{m}}_{out} - {c}_{V} T ( {\dot{m}}_{in} - {\dot{m}}_{out} ) ) \qquad ( 14 )$$

Here, cᵥ and cₚ [J/(kg K)] are gas specific heat capacities for constant volume and constant pressure, respectively. A further differential equation of the four types of differential equations may be the differential equation of the mass fraction of a gas species, X:

$$\frac{dX}{dt} = \frac{\tilde{R} T}{pV} ( {\dot{m}}_{in} {X}_{in} - {\dot{m}}_{out} X ) \qquad ( 15 )$$

Here, X is the gas species fraction in the volume and Xᵢₙ is the same species mass fraction in the gas flowing into the volume. The last of the four types of differential equations may be the differential equation of a turbocharger speed:

$$\frac{dN}{dt} = {( \frac{\text{?}}{\text{?}} )}^{2} \frac{1}{\text{?}} \frac{{W}_{\text{?}} - {W}_{\text{?}}}{N} \\ \text{?} \text{indicates text missing or illegible when filed} \qquad ( 16 )$$

Here, N [rpm] is the turbo charger rotational speed, W_{turb} [W] is mechanical power of the turbine and W_{comp} is mechanical power absorbed by the compressor. I [kg m²] is the turbocharger momentum of inertia.

The four types of differential equations may represent mass, energy, and matter conservation laws combined with the ideal gas equation. The terms appearing on the right-hand side of each of the four types of differential equations may be defined by the engine components, such as turbine and compressor maps and/or valve characteristics. In one example, the turbine power, W_{turb}, appearing in equation (16) may be expressed in terms of turbine mass flow, turbine pressure ratio, and/or turbine inlet temperature, as well as isentropic efficiency which may be modeled empirically (e.g., modeled by fitting to turbine gas data):

$${\dot{W}}_{\text{?}} = {F}_{2} {c}_{p} {T}_{3} ( 1 - {( \frac{{p}_{3}}{{p}_{1}} )}^{\frac{\text{?} - γ}{γ}} ) η ( \frac{{p}_{3}}{{p}_{1}} , N ) \\ \text{?} \text{indicates text missing or illegible when filed} \qquad ( 17 )$$

The set of four types of differential equations may be expressed using a state-space representation that may group variables into states, x, (e.g., pressures, temperatures, concentrations, turbo speed), inputs, u, (both actuators positions and disturbances), and outputs measured by physical sensors, y:

$$\begin{matrix}\frac{dx ( t )}{dt} = f ( t , x ( t ) ) & ( 18 ) \\ y ( t ) = g ( t , x ( t ) ) & ( 19 )\end{matrix}$$

Here, the function f defines the right-hand sides of the differential equations and the function g defines the model values for physical sensors. These functions are time dependent, possibly through the vector inputs of u.

The above differential equations may be stiff and, generally, may be solved with variable step ODE solvers. Such variable step ODE solvers may require large quantities of processing power and/or memory. For the purpose of real-time simulations and/or estimates (e.g., during operation of the engine 12) on an ECM/ECU or other on-line portion of the controller 18, the equations may be modified to project a state vector to a lower dimension (e.g., lower order), such as do DAE based models.

The air-path state estimator 26 may solve an optimization problem on a time window (finite or infinite) to minimize the norm of prediction errors. In some cases, the optimization problem may take the following form:

$${min}_{x ( t )} {\sum }_{{τ}_{k} = 0}^{t} {‖ {y}_{sens} ( {τ}_{k} ) - g ( {τ}_{k} , x ( {τ}_{k} ) ) ‖}_{R}^{2} \\ subj . to \frac{dx}{d τ} = q ( τ , x ( τ ) ) , τ ∈ [ 0 , t ] \qquad ( 20 )$$

Where, at the current time (at time t), the air path state estimator 26 may minimizes certain quadratic norm ∥∥_{R}² of the model prediction errors (e.g., the norm of differences between the sensed values yₛₑₙₛ(τₖ) and the model predicted values g(τₖ,u(τₖ))). The prediction errors at certain discrete time instants τₖ are considered in the optimization. This optimization respects that the air-path estimated state trajectory must satisfy the model differential equations. Here, the functions q,g may correspond to the second model represented and simulated in the on-line portion of the controller. The result of the optimization problem may define the current intake and/or exhaust manifold conditions, which may be needed for calculations by the NOx concentration module 27, other downstream virtual sensors, and/or downstream diagnostics. An output 38 of may proceed from concentration module 27.

The air-path state estimator 26 (e.g., a module in the on-line portion 32 of the controller 18 that may include a mean-value air path model or other model) may be used in one or more engine monitoring and/or control approaches. In one example, the air path state estimator 26 may be used in an approach 100, as shown in FIG. 3, for determining conditions of an engine in operation based, at least in part, on signal values of a variable sensed by one or more sensors in communication with the engine 12. At box 102 of the approach 100, one or more differential equations and/or functions (e.g., ordinary differential equations and/or other differential equations) configured to model a parameter of an engine may be received and/or identified (e.g., received and/or identified at the off-line portion 30 of the controller 18). Example engine parameters that may be modeled include, but are not limited to, an intake manifold temperature of the engine 12, an intake manifold pressure of the engine 12, an intake manifold gas concentrations of the engine 12 (e.g., N₂, O₂, CO2, H₂0, and so forth), an in-cylinder charge mass, an in-cylinder charge temperature, an in-cylinder charge gas composition, an in-cylinder residual mass temperature, an in-cylinder residual mass gas composition, a pressure between components of an engine, a temperature between components of an engine, mass fractions of one or more gasses in an engine, a speed of a turbocharger of an engine. Values of these engine parameters that may be modeled may be outputted from the air-path state estimator 26.

At box 104 in the approach 100 shown in FIG. 3, right hand sides of the received ODEs may be transformed (e.g., converted) into one or more differential functions, wherein the one or more ODEs may at least partially form a first model of the engine 12 having a first order and the one or more differential functions may be configured to at least partially form a second model of the engine having an order lower than the first order. In some cases, the first model and the second model may result in similar outputs when similar inputs are received, but with the second model requiring less processing time and/or power to produce the output. The transformed differential functions may include one or more algebraic differential equations and differentiable functions (e.g., fractions of differential functions and/or one or more other types of functions). In one example, the right-hand sides of the received ordinary differential equations may be transformed or converted into algebraic differential equations and one or more of rational polynomial functions, fractions of polynomials, differential functions, and rational differentiable functions. Other transformations and/or conversions may be utilized as desired.

Then, at box 106 in the approach 100 of FIG. 3, differential functions having a fractional form may be reconfigured into implicit algebraic equations. This step may be performed when the denominators tend to zero and/or at other times. In one example, reconfiguring the differential functions having a fractional form into an implicit algebraic equation may include multiplying by the denominators of the differential functions to ensure the equations do not necessarily require division by zero, as shown with respect to equation (9). Further, in some cases, the numerators may be made equal to zero, as shown above in equation (10). Such configuring of the differential functions may result in a model of a system having DAEs and differentiable functions, which may be equivalent to assuming all or substantially fast dynamics of the functions may be in steady state. Once the model of a system having DAEs and differentiable functions having a lower order than the original ODE model has been developed, the lower order model may be considered calibrated for the engine 12 and sent from the off-line portion 30 of the controller 18 to the on-line portion 32 of the controller 18 to determine parameter states of the engine based, at least in part, on the developed model.

Then, the air-path state estimator 26 may calculate, at box 108, one or more parameter values (e.g., conditions) of one or more in-cylinder gases while the engine 12 is in operation (e.g., current conditions of the engine). The calculated one or more parameter values of the in-cylinder gas may be based, at least in part, on signal values for sensed variables received from sensors 14 and the differential and algebraic equations (e.g., the differential and algebraic equations constituting the second model of the engine). As discussed, the calculated one or more parameter values of the in-cylinder gas may be used as boundary conditions, initial in-cylinder gas conditions, engine air-path estimates, and/or other inputs for downstream virtual sensor modules and/or control algorithms. Alternatively, or in addition, the outputs of the air-path state estimator 26 may be displayed on a display (e.g., a display in communication with the controller 18) and/or used in an on-board diagnostics system (e.g., an on-board diagnostics system configured to monitor operation of the engine 12).

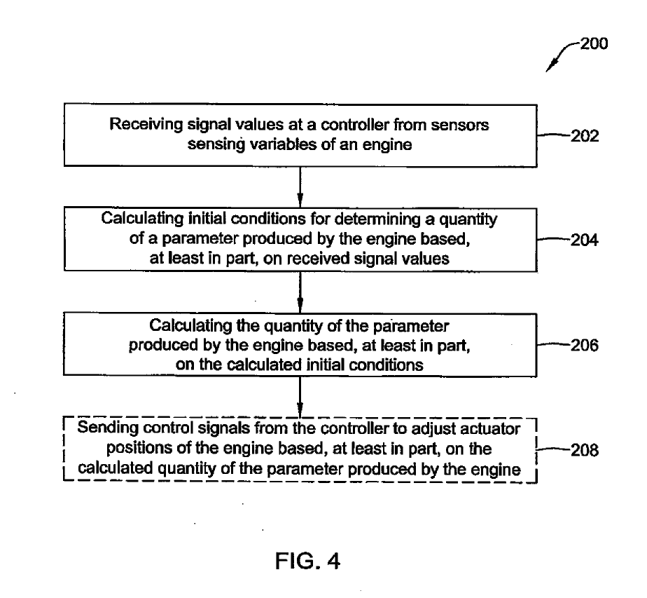

In FIG. 4, one or more modules (e.g., the air-path state estimator 26 and a virtual sensor (e.g., the NOx concentration module 27)) in the on-line portion 32 of the controller 18 may be utilized in an approach 200 of monitoring a quantity of a parameter (e.g., NOx, and so on) produced by engine 12. The approach 200 may include receiving, at box 202, signal values relating to the engine 12 (e.g., an operating engine) at the controller 18 from one or more sensors 14 sensing variables of the engine 12. At box 204, one or more parameter values for the in-cylinder gas may be determined (e.g., calculated) with a first module (e.g., the air-path state estimator 26 or other module) in the controller 18. In one example, the one or more determined parameter values of the in-cylinder gas may be determined based, at least in part, on the model developed according to approach 100 of FIG. 3 and/or may be determined based, at least in part, on one or more other models. Illustratively, the determined parameter values of the in-cylinder gas may be utilized as initial conditions in a downstream module for determining a quantity of a parameter produced by the engine. Alternatively, or in addition, the determined parameter values of the in-cylinder gas may be used for diagnostics and/or monitoring of the engine 12. In some cases, the produced parameter values of the in-cylinder gas may be calculated in real-time (e.g., as the engine is operating) with the on-line portion 32 of the controller 18. Example in-cylinder gas parameters (e.g., engine parameters) for which values may be estimated by the air-path state estimator 26 may include, but are not limited to, an intake manifold temperature of the engine 12, an intake manifold pressure of the engine 12, intake manifold gas concentrations of the engine 12 (e.g., N₂, O₂, CO2, H₂0, and so on), in-cylinder charge mass, in-cylinder charge temperature, in-cylinder charge gas concentrations, in-cylinder residual mass temperature, in-cylinder residual mass gas concentrations, and so forth.

Based, at least in part, on the calculated parameter values of the in-cylinder gas, a second module (e.g., a downstream module, such as a NOx concentration module 27) in the on-line portion 32 of the controller 18 may determine (e.g., calculate) a value or quantity of a parameter produced by the engine 12, as shown at box 206 in FIG. 4. In some cases, the value or quantity of the parameter produced by the engine (e.g., NOx concentration in exhaust gas of the engine) may be calculated in real-time (e.g., as the engine is operating) with the online portion 32 of the controller 18.

Once the value or quantity of the parameter produced by the engine 12 is determined, the value or quantity of the parameter produced by the engine may be used as an input to a display (e.g., in an on-board diagnostics system or other diagnostics system), as an input to a further virtual sensor or module, and/or as an input to a control algorithm. In one optional example, as shown by dashed box 208 of FIG. 4, a control signal may be sent from the controller 18 to the engine 12 to adjust one or more actuator positions of the engine based, at least in part, on the quantity or value of the parameter produced by the engine 12. The control signal sent from the controller 18 to the engine 12, if any, may be configured and/or timed to adjust actuators 16 of the engine 12 in real-time and result in adjusting the value of the parameter produced by the engine 12 (e.g., the NOx concentration in exhaust gas of the engine 12) while the engine 12 may be operating.

In one case, a control signal may be sent from the controller 18 to the engine 12 to an on-board diagnostics system in two-way communication with the controller 18 and configured to monitor operation of the engine 12. In one example, the control signal(s) sent to the on-board diagnostics system may affect what is displayed on a display of the on-board diagnostics system, instruct the on-board diagnostics system to create and/or log a report, instruct the on-board diagnostics system to sound and/or display an alarm, and/or may communicate one or more other instruction to the on-board diagnostics system.

A recap may be provided in the following. An engine system may incorporate an engine, one or more sensors, and a controller. Each of the one or more sensors may be configured to sense one or more parameters related to operation of the engine. The controller may incorporate one or more virtual sensors configured to estimate one or more air-path state parameters related to the operation of the engine based, at least in part, on values of one or more parameters sensed by one or more of the sensors.

The one or more virtual sensors may incorporate an air-path state estimator configured to estimate one or more of an intake manifold temperature of the engine, an intake manifold pressure of the engine, an exhaust manifold pressure of the engine, a fuel per stroke of the engine, intake manifold gas composition of the engine, an in-cylinder charge mass, an in-cylinder charge temperature, an in-cylinder charge pressure, an in-cylinder charge composition, a residual mass temperature, and a residual mass composition. The air-path state estimator may estimate one or more other parameters related to an engine.

The one or more virtual sensors of the controller may incorporate an air-path state estimator. Additionally, or alternatively, the one or more virtual sensors of the controller may incorporate a NOx concentration module.

The air path estimator may determine initial conditions for the NOx concentration module.

The controller of the engine system may incorporate a plurality of control units.

The controller of the engine system may incorporate an off-line portion and an on-line portion. The on-line portion may be configured to incorporate an air-path state estimator module of a virtual sensor. The air-path state estimator module may be configured to estimate the one or more air-path state parameters related to the operation of the engine. The off-line portion may be configured to determine one or more differential equations for an air-path state estimator module.

The controller may incorporate a plurality of control units. A first control unit of the controller may incorporate the off-line portion of the controller. A second control unit of the controller may incorporate the on-line portion and may be in communication with the first control unit.

The off-line portion of the controller may be configured to transform right-hand sides of one or more ordinary differential equations. The off-line portion may be configured to transform the right-hand sides of the ordinary differential equations into one or more differentiable right-hand side functions and one or more fractions of differentiable functions which can be represented by algebraic equations with differentiable functions whenever the denominator is close to zero.

The engine of the engine system may incorporate one or more turbochargers. Based on values of the parameters sensed by the one or more sensors, the air-path state estimator may solve one or more of a differential equation of pressure between components in a volume of the engine, a differential equation of temperature between components of the engine, and a differential equation of a turbocharger speed of one or more turbochargers.

An approach of monitoring a quantity of a parameter produced by an engine with one or more modules in a controller that is in communication with the engine. The approach may incorporate receiving signal values at a controller from one or more sensors sensing variables of an engine. A first module of the controller may be configured to calculate one or more initial conditions of the in-cylinder gas for determining a quantity of a parameter produced by the engine based, at least in part, on one or more received signal values. The controller may incorporate a second module configured to calculate the quantity of the parameter produced by the engine based, at least in part, on the calculated initial conditions of the in-cylinder gas.

The approach of monitoring may further incorporate sending control signals from the controller to adjust actuator positions of the engine. The control signals may be configured to adjust actuator positions of the engine based, at least in part on the calculated quantity of the parameter produced by the engine.

The approach of monitoring may further incorporate sending control signals from the controller to an on-board diagnostics system configured to monitor operation of the engine.

The first module used in the approach of monitoring may incorporate an air-path state estimator. The air-path state estimator may be configured to determine one or more initial conditions for determining the quantity of the parameter produced by the engine in real-time and on-line during operation of the engine.

In the approach of monitoring, the one or more initial conditions for determining the quantity of the parameter produced by the engine may incorporate one or more of an intake manifold pressure of the engine, an intake manifold temperature of the engine, an exhaust manifold pressure of the engine, a fuel per stroke of the engine, one or more gas compositions in the intake manifold of the engine, in-cylinder charge mass, in-cylinder charge temperature, in-cylinder charge pressure, in-cylinder charge composition, residual mass temperature, and residual mass composition.

In the approach of monitoring, one or more differential equations in the first module may be used to calculate the one or more initial conditions. The one or more initial conditions may be for determining the quantity of the parameter produced by the engine.

The one or more differential equations may incorporate a differential equation modeling pressure between components of an engine, a differential equation modeling temperature between components of an engine, a differential equation modeling a mass fraction of one or more gasses in an engine, and/or a differential equation modeling a speed of a turbocharger of an engine.

The one or more differential equations in the first module may be configured in an off-line portion of the controller. The one or more differential equations may be configured by converting ordinary differential equations configured to model engine parameter values to a same or lower number of differential equations including one or more algebraic equations.

An approach may be used for determining conditions of an engine in operation based, at least in part, on signal values sensed by one or more sensors in communication with the engine. The approach may incorporate receiving one or more ordinary differential equations configured to model a parameter of an engine. Right hand sides of the one or more differential equations may be transformed into one or more functions represented as fractions of differentiable functions. The one or more ordinary differential equations may be configured to at least partially form a first model of an engine having a first order and the one or more differential functions may be configured to at least partially form a second model of the engine having an order lower than the first order. Fractions of the differentiable functions of the second model may be reconfigured into implicit algebraic equations considering the numerators of fractions to be zero whenever the denominator becomes close to zero. The approach of determining conditions of an engine may further incorporate calculating the one or more conditions of in-cylinder gas while the engine is in operation based, at least in part, on sensed signal values and the second model of the engine having an order lower than the first order.

The approach for determining conditions of the engine may incorporate using one more of the calculated initial conditions of the in-cylinder gas to determine parameter values for a parameter of the operating engine.

The approach for determining conditions of the engine may incorporate adjusting positions of the actuators of the engine. In one example, the positions of the actuators of the engine may be adjusted with control signals from the control response to the determine parameter values for the parameter of the operating engine.

Any publication or patent document noted herein is hereby incorporated by reference to the same extent as if each individual publication or patent document was specifically and individually indicated to be incorporated by reference.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to incorporate all such variations and modifications.

What is claimed is:

1. An engine system comprising:
an engine;
one or more sensors each configured to sense one or more parameters related to operation of the engine; and
a controller connected to the engine; and
wherein the controller is configured to incorporate one or more virtual sensors configured to estimate one or more air-path state parameters related to the operation of the engine based, at least in part, on values of one or more parameters sensed by one or more of the sensors.

2. The system of claim 1, wherein the one or more virtual sensors incorporate an air-path state estimator configured to estimate one or more of an intake manifold temperature of the engine, intake manifold pressure of the engine, exhaust manifold pressure of the engine, fuel per stroke of the engine, intake manifold gas composition of the engine, in-cylinder charge mass, in-cylinder charge temperature, in-cylinder charge pressure, in-cylinder charge composition, residual mass temperature, and residual mass composition.

3. The system of claim 1, wherein the one or more virtual sensors incorporate an air-path state estimator and a NOx concentration module.

4. The system of claim 3, wherein the air-path state estimator determines initial conditions for the NOx concentration module.

5. The system of claim 1, wherein the controller comprises a plurality of control units.

6. The system of claim 1, wherein the controller comprises:
an off-line portion; and
an on-line portion configured to incorporate an air-path state estimator module of a virtual sensor, the air-path state estimator module configured to estimate the one or more air-path state parameters related to the operation of the engine; and
wherein the off-line portion is configured to determine one or more differential equations for the air-path state estimator module.

7. The system of claim 6, wherein the controller comprises a plurality of control units and a first control unit incorporates the off-line portion and a second control unit that incorporates the on-line portion and is in communication with the first control unit.

8. The system of claim 6, wherein the off-line portion of the controller is configured to transform right-hand sides of one or more ordinary differential equations into one or more differentiable right-hand side functions and one or more fractions of differentiable functions which can be represented by algebraic equations with differentiable functions whenever the denominator is close to zero.

9. The system of claim 2, wherein:
the engine comprises one or more turbochargers; and
based on values of the parameters sensed by the one or more sensors, the air-path state estimator solves one or more of the following:
a differential equation of pressure between components in a volume of the engine;
a differential equation of temperature between components of the engine;
a differential equation of a mass fraction of a gas species in the engine; and
a differential equation of a turbocharger speed of one or more turbochargers.

10. A method of monitoring a quantity of a parameter produced by an engine with one or more modules in a controller that is in communication with the engine, the method comprising:
receiving signal values at a controller from one or more sensors sensing variables of an engine;
with a first module in the controller, calculating one or more initial conditions of an in-cylinder gas for determining a quantity of a parameter produced by the engine based, at least in part, on one or more received signal values; and
with a second module in the controller, calculating the quantity of the parameter produced by the engine based, at least in part, on the calculated initial conditions of the in-cylinder gas.

11. The method of claim 10, further comprising sending control signals from the controller to adjust actuator positions of the engine based, at least in part, on the calculated quantity of the parameter produced by the engine.

12. The method of claim 10, further comprising sending control signals from the controller to an on-board diagnostics system configured to monitor operation of the engine.

13. The method of claim 10, wherein the first module incorporates an air path state estimator configured to determine one or more initial conditions for determining the quantity of the parameter produced by the engine in real-time and on-line during operation of the engine.

14. The method of claim 10, wherein the one or more initial conditions for determining the quantity of the parameter produced by the engine incorporate one or more of an intake manifold pressure of the engine, an intake manifold temperature of the engine, an exhaust manifold pressure of the engine, a fuel per stroke of the engine, one or more gas compositions in an intake manifold of the engine, in-cylinder charge mass, in-cylinder charge temperature, in-cylinder charge pressure, in-cylinder charge compositions, residual mass temperatures, and residual mass compositions.

15. The method of claim 11, wherein one or more differential equations in the first module are used to calculate the one or more initial conditions for determining the quantity of the parameter produced by the engine.

16. The method of claim 15, wherein the one or more differential equations incorporate a differential equation modeling pressure between components of an engine, a differential equation modeling temperature between components of an engine, a differential equation modeling a mass fraction of one or more gasses in an engine, and a differential equation modeling a speed of a turbocharger of an engine.

17. The method of claim 15, wherein the one or more differential equations are configured in an off-line portion of the controller by converting ordinary differential equations configured to model engine parameter values to a same or lower number of differential equations including one or more algebraic equations.

18. A method of determining conditions of an engine in operation based, at least in part, on signal values sensed by one or more sensors in communication with the engine, the method comprising:
receiving one or more ordinary differential equations configured to model a parameter of an engine;
transforming right-hand sides of one or more ordinary differential equations into one or more functions represented as fractions of differentiable functions, wherein the one or more ordinary differential equations are configured to at least partially form a first model of an engine having a first order and the one or more differential functions are configured to at least partially form a second model of the engine having an order lower than the first order;
reconfiguring fractions of differentiable functions of the second model into implicit algebraic equations considering numerators of fractions to be zero whenever a denominator of the fractions becomes close to zero; and
calculating one or more conditions of in-cylinder gas while the engine is in operation based, at least in part, on sensed signal values and the second model of the engine having an order lower than the first order.

19. The method of claim 18, further comprising using one or more of the calculated initial conditions of the in-cylinder gas to determine parameter values for a parameter of the operating engine.

20. The method of claim 19, further comprising adjusting positions of actuators of the engine with control signals from a controller in communication with the engine in response to the determined parameter values for the parameter of the operating engine.
